(19) United States
(12) Patent Application Publication
(10) Pub. No.: US 2004/0226954 A1
(43) Pub. Date: Nov. 18, 2004

(54) Assembly for the movement of a paint tray

(76) Inventor: Tom Pasinski, Chicago, IL (US)

Correspondence Address: LADAS & PARRY LLP, 224 SOUTH MICHIGAN AVENUE, SUITE 1200, CHICAGO, IL, 60604, US

(21) Appl. No.: 10/784,658

(22) Filed: Feb. 23, 2004

Related U.S. Application Data
(60) Provisional application No. 60/449,705, filed on Feb. 24, 2003.

(51) Int. Cl. B43L 1/00

(52) U.S. Cl. 220/570

(57) ABSTRACT

An assembly for the movement of paint trays. The assembly includes an upwardly orientated opening through which an end of a paint roller may be inserted to push, pull, rotate and maneuver a paint tray. The assembly may be removably or permanently affixed to the paint tray, and the assembly may be provided alone or incorporated directly into the paint tray itself or the ramp surface of the paint tray.

### BACKGROUND OF THE INVENTION

1. Field of the Invention

The present invention relates generally to painting equipment. More specifically, the present invention relates to an assembly for use with a paint tray to facilitate easy movement of the paint tray when engaged by a roller.

2. Description of the Related Art

Various paint tray assemblies have been used for applying a liquid, like paint, to a roller. Such paint trays are typically rectangular in shape having a partially ramped rectangular bottom surface. The ramped bottom surface starts at the back wall of the tray, and slopes downward to the bottom of the tray as it extends toward the front of the tray. Sidewalls extend around the rectangular bottom surface forming a reservoir for holding paint, which is deeper near the front of the tray and shallower toward the back.

When using such a paint tray, a painter typically approaches the paint tray from the back of the pain tray and will extend the roller into the paint located in the reservoir. Once the paint is absorbed into the roller, the painter pulls the roller back along the ramped bottom surface causing the paint to spread onto the roller with excess paint draining back into the reservoir.

Due to the shape of the tray and the orientation of the ramped bottom surface, the paint can only be conveniently applied to the roller from one direction. As a painter moves around the room, unless the paint tray is continuously reoriented, the painter is often in a poor position to reapply more paint to the roller. The painter in many instances must walk around to the back of the tray in order to reapply more paint to the roller.

Several examples of previously disclosed analogous and non-analogous paint tray assemblies allowing for the painter to apply paint to the roller from a plurality of positions around a room without having to pick up and reorient the paint tray, or paint tray assemblies providing transport mechanisms for assisting in the movement or reorientation of the paint tray are contained in the following U.S. patents.

Elliot et al., U.S. Pat. No. 5,169,022 discloses a circular paint tray assembly providing a center circular well for holding paint and a sloping paint spreading surface which extends around the circular well the full circumference of the tray. By extending around the full circumference of the tray, the ramped paint spreading surface allows a painter to apply paint to a roller from any position around the tray, without having to pick up and reorient the paint tray.

Owens, U.S. Pat. No. 5,046,749 discloses a U-shaped paint pail having two steeply sloped surfaces for applying paint to a roller. The two sloped surfaces are positioned opposite one another. The two sloped surfaces allow for two painters to simultaneously apply paint to their roller, or to allow a single painter to apply paint to a roller from one of two positions around the paint pail. The U-shaped paint pail is further mounted on four casters to allow the paint pail to be rolled from one area to another. In the preferred embodiment, the direction of rotation of two casters is limited so as to restrict the movement of the pail to a straight line, often parallel to a wall.

Schumacher et al., U.S. Pat. No. 5,082,301 discloses a mobile work station or cart with wheels and a handle, for holding a paint tray and other paint supplies. The wheels and the handle serve to facilitate movement of the work station as the painter moves from one work area to another work area.

Dunn, U.S. Pat. No. 3,752,494 discloses a paint cart assembly including a roller frame assembly, which may be used to assist in the movement of the cart assembly into an advantageous position with respect to the surfaces being painted and the position where the painter is working.

Pasinski, U.S. Pat. No. 5,984,129 discloses a paint tray having a top portion with a contact point to rotate the top portion of the paint tray to face the painter. An engagement point is also disclosed by which the paint tray may be pulled towards the painter by hooking a portion of the roller. However, it remains difficult for a painter to push the paint tray or maneuver the paint tray sideways by these contact and engagement points.

Thus, the need exists for a paint tray assembly by which a user may push, pull, rotate and maneuver sideways a paint tray by a single means.

### SUMMARY OF THE INVENTION

The present invention provides an assembly for use with a paint tray in which the assembly includes an upwardly orientated opening through which an end of a roller may be inserted. The assembly may be removably or permanently attached to the paint tray, incorporated into a ramped surface of the paint tray, and incorporated directly into the paint tray.

A painter applying liquid to a roller from the paint tray may easily reposition and maneuver the paint tray by inserting an end of the roller into the opening to push, pull, rotate and maneuver the paint tray about a support surface.

### BRIEF DESCRIPTION OF THE DRAWINGS

FIG. 1 is a perspective view of a conventional paint tray with an embodiment of the assembly of the present invention in place.

FIG. 2 is a side view of an embodiment of the assembly of the present invention.

FIG. 3 is a top view of an embodiment of the assembly of the present invention.

FIG. 4 is a perspective view of a ramped surface in which the assembly has been incorporated.

FIG. 5 is a perspective view of the ramped surface shown in FIG. 4, in use with a paint tray.

FIG. 6 is a top view of the ramped surface and paint tray shown in FIG. 5.

FIG. 7 is a perspective view of another paint tray in use with the ramped surface shown in FIG. 4.

FIG. 8 is a perspective view of a roller used to apply a liquid.

### DETAILED DESCRIPTION OF THE PREFERRED EMBODIMENTS

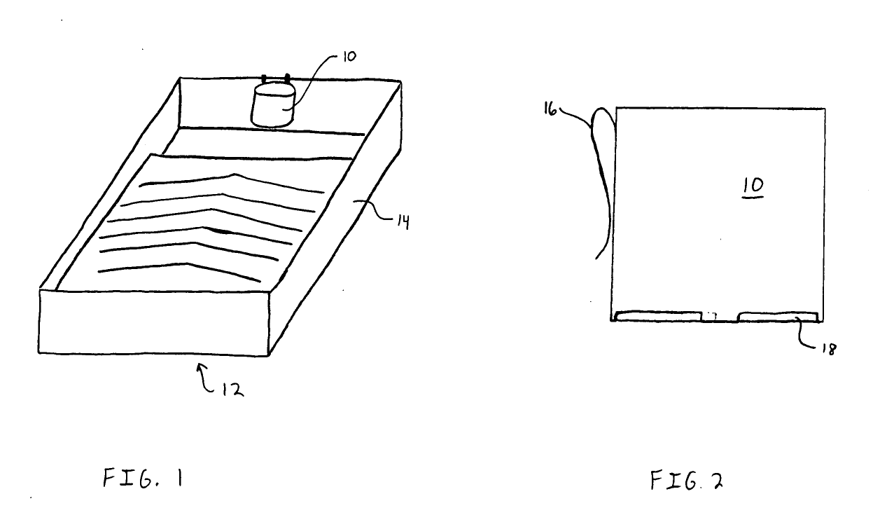

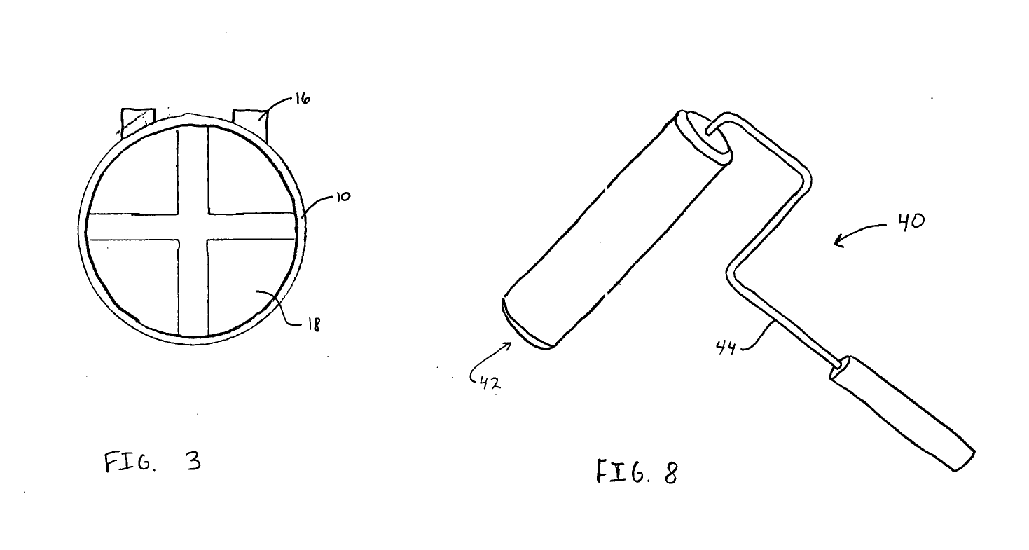

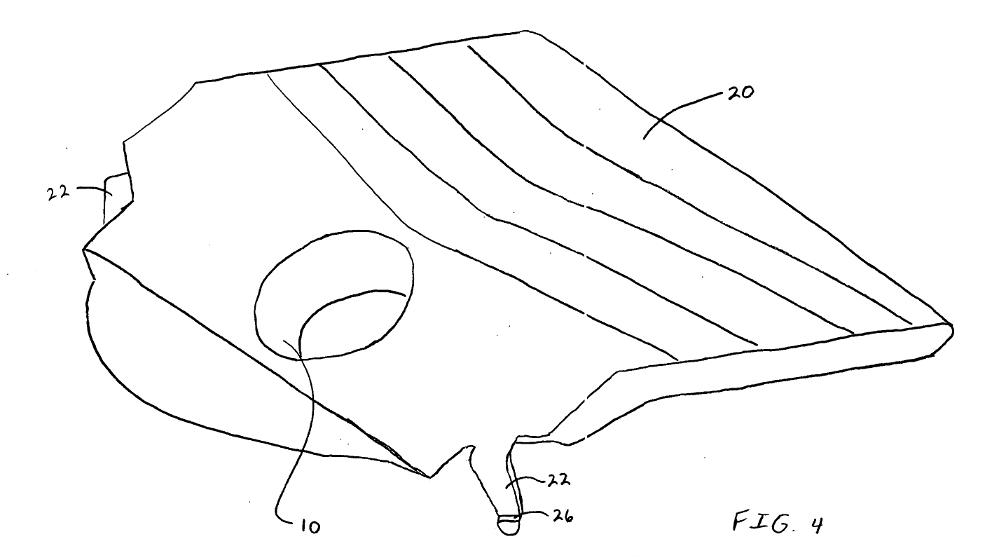

Shown in FIGS. 1-3 is an embodiment of the assembly 10 for use with conventional paint trays. The assembly 10 has an upwardly orientated opening defined by an inner wall. The assembly may take various forms and shapes. The opening is shaped and configured to receive an end 42 of a roller 40 or other implement. An example of a roller 40 is shown in FIG. 8. The assembly 10 preferably is in the shape of a cup, and has a circular opening.

This embodiment of the assembly 10 may be located anywhere on the paint tray 12. The assembly may be affixed to the paint tray 12 by any means conventionally known. In this embodiment the assembly 10 is removably affixed to the sidewall 145 of the paint tray 12 by spring clips 16. Other means to removable affix the assembly 10 include, but are not limited to screws, hook and loop fasteners, clamps, interconnecting slots and channels, etc. The assembly 10 may also be permanently affixed to a paint tray by various means including, but not limited to, rivets, adhesives, welding, molding, etc.

The assembly 10 is preferably located within the paint tray 10, so that liquid deposited within the assembly 10 will flow through a drain 18 located in the assembly 10, to collect in the paint tray 12.

To reposition the paint tray 12, an end 42 of a roller 40 is first inserted down into the opening of the assembly 10. With the end 42 of the roller 40 disposed in the opening of the assembly 10, lateral forces may be applied to push, pull, rotate and maneuver sideways the paint tray 10, by the roller 40, to any position and orientation upon a support surface.

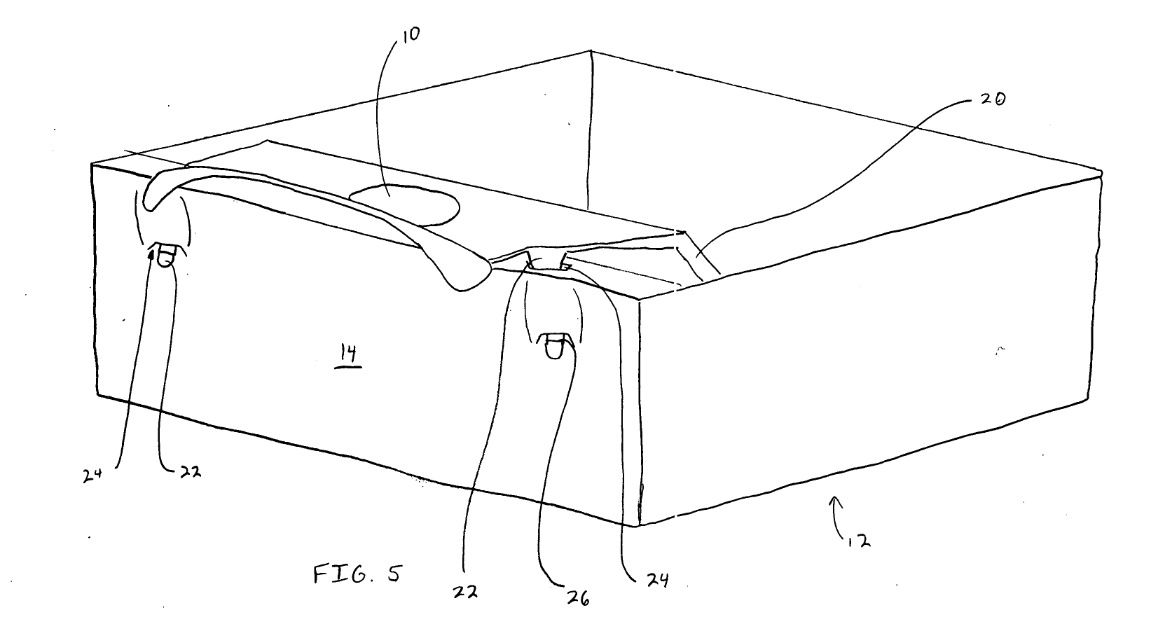

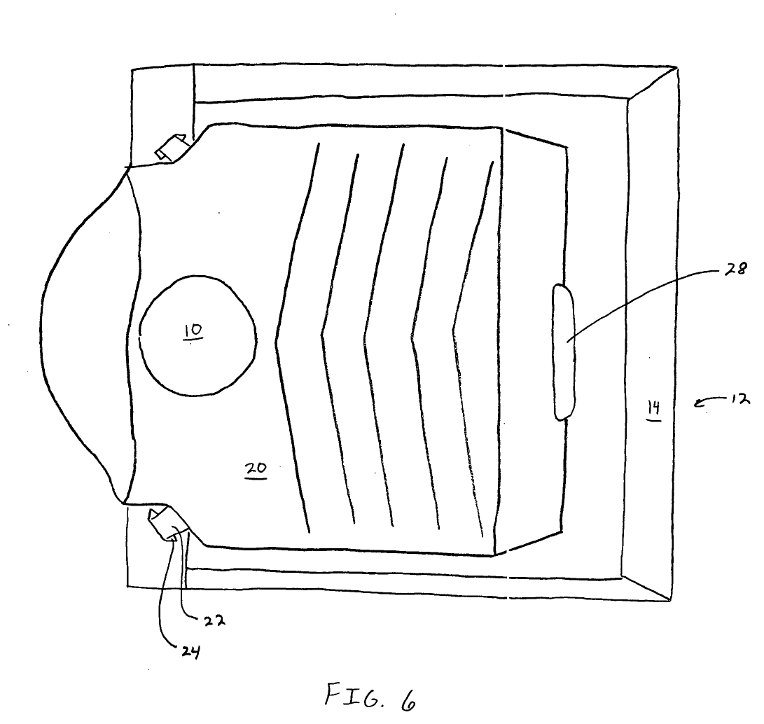

FIG. 4 shows the assembly 10 incorporated into a ramped surface 20, on which liquid may be applied to a roller 40. The ramped surface 20 may be directly incorporated into a paint tray 12, however, it is preferred to have the ramped surface be removably attached to the paint tray 12, as shown in FIGS. 5 and 6, to facilitate easier cleaning of the ramped surface 20 and the paint tray 12. The ramped surface 20 may also be attached to the paint tray 12 by any other means conventionally known.

The embodiment of the ramped surface shown in the figures include posts 22 which fit into channels 24 formed in the sidewall 14 of the paint tray 12. The posts 22 may fit tightly into the channels 24 to provide a press-fit connection, and/or the posts 22 may be shaped with a small indentation or ledge 26 to provide a snap-fit connection with the channel 24.

In the embodiment shown in FIG. 6, the ramped surface 20 is also removably connected to an inner bottom surface of the paint tray 12 by a lip 28 which extends from the inner bottom surface of the paint tray over an end of the ramped surface 20.

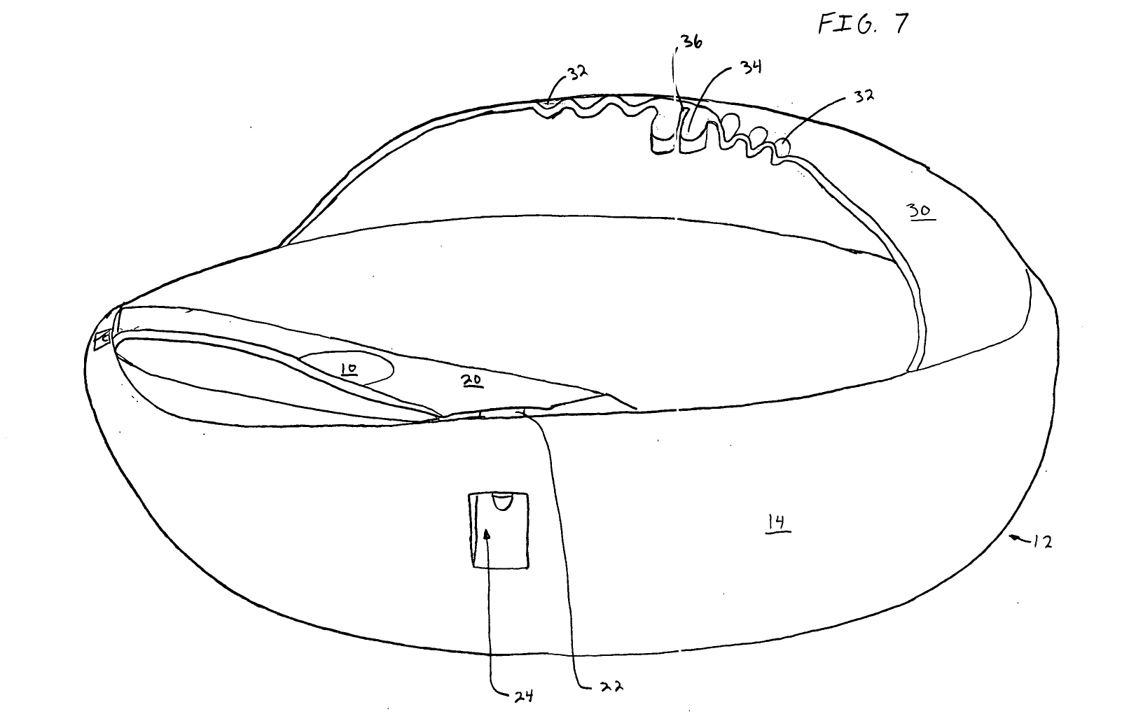

FIG. 7 also shows another preferred embodiment in which the ramped surface 20 is removably connected to a paint tray 12 having a rounded external surface. The rounded external surface allows for easier maneuvering of the paint tray 12 over a support surface. The paint tray 12 further includes a hood 30 with indentations 32 provided thereon so that the paint tray 12 may also be pulled by hooking a roller 40 or other implement on an indentation 32 on the hood. From the front edge of the hood there is also provided a retaining portion 34 having a space 36 in which the wire handle 44 of a roller 40 may be inserted to retain the roller in an upright position. In this preferred embodiment the retaining portion 34 extends forward from the front edge of the hood to provide another edge by which the paint tray 12 may be hooked by a roller or other implement.

As will be apparent to those skilled in the art to which the invention is addressed, the present invention may be embodied in forms other than those preferred embodiments specifically disclosed above, without departing from the spirit or essential characteristics of the invention. The particular embodiments of the invention described above are therefore to be considered in all respects as illustrative and not restrictive. The scope of the present invention is as set forth in the appended claims.

I claim:

1. An assembly for movement of a paint tray, said assembly comprising:
an inner surface defining an upwardly orientated opening through which an end of a paint roller may be inserted down through said opening for pushing, pulling, rotating and maneuvering the paint tray.

2. The assembly according to claim 1, wherein said assembly is removably affixed to said paint tray.

3. The assembly according to claim 1, wherein said assembly is permanently affixed to said paint tray.

4. The assembly according to claim 1, wherein said opening is circular.

5. the assembly according to claim 4, wherein said inner surface forms a cup.

6. The assembly according to claim 1, further comprising a ramped surface.

7. The assembly according to claim 6, wherein said assembly is removably affixed to said paint tray.

8. The assembly according to claim 7, wherein said ramped surface is removably affixed to a sidewall of said paint tray.

9. The assembly according to claim 8, wherein said ramped surface includes at least one post shaped and configured to be received within at least one channel in said sidewall.

10. The assembly according to claim 9, wherein said at least one post is press-fit into said at least one channel.

11. The assembly according to claim 9, wherein said at least one post is snap-fit into said at least one channel.

12. The assembly according to claim 8, wherein said ramped surface is also removably affixed to an inner bottom surface of said paint tray.

13. The assembly according to claim 6, wherein said assembly is permanently affixed to said paint tray.

14. The assembly according to claim 6, wherein said opening is circular.

15. The assembly according to claim 14, wherein said inner surface of the assembly forms a cup, said cup having a drain at a bottom of the cup.

16. A paint tray assembly for applying a liquid to a roller, said paint tray assembly comprising:
a bottom side adapted for resting upon a support surface;
a reservoir having a floor and a sidewall extending around said sidewall for retaining the liquid; and
an inner surface defining an upwardly orientated opening through which an end of the roller may be inserted through said opening for pushing, pulling, rotating and maneuvering the paint tray assembly about the support surface.

17. The paint tray assembly according to claim 16, further comprising a ramped surface disposed within said reservoir.

18. The paint tray assembly according to claim 17, wherein said opening is provided through said ramped surface.

19. The paint tray assembly according to claim 18, wherein the inner surfaces of said engagement point forms a cup, said cup having a drain through which liquid deposited from said roller may flow back into said reservoir.

20. The paint tray assembly according to claim 19, wherein said ramped surface is removably affixed to a sidewall of said paint tray.

21. The paint tray assembly according to claim 20, wherein said ramped surface includes at least one post shaped and configured to be received within at least one channel in said sidewall.

22. The paint tray assembly according to claim 21, wherein said at least one post is press-fit into said at least one channel.

23. The paint tray assembly according to claim 21, wherein said at least one post is snap-fit into said at least one channel.

24. The paint tray assembly according to claim 20, wherein said ramped surface as also removably affixed to said floor.

25. The paint tray assembly according to claim 16, wherein an external surface of said paint tray assembly is sloped for forming said paint tray assembly having an external circumference narrower at said bottom side of said paint tray assembly where said bottom side rests upon the support surface.

26. The paint tray assembly according to claim 16, wherein a portion of said sidewall forms a hood which extends up and back over said reservoir to partially enclose said reservoir from above.

27. The paint tray assembly according to claim 26, wherein a front edge of said hood includes at least one indentation for hooking and pulling said paint tray by said roller.

28. The paint tray assembly according to claim 26, wherein a roller retaining portion is provided at a front edge of said hood to retain the roller in an upright position.
